(19) United States
(12) Patent Application Publication
(10) Pub. No.: US 2008/0273265 A1
(43) Pub. Date: Nov. 6, 2008

(54) Determining smear of a hard disk drive slider

(76) Inventors: Glenn P. Gee, San Jose, CA (US); David J. Seagle, Morgan Hill, CA (US); Hicham M. Sougrati, Burlingame, CA (US); Jila Tabib, Los Gatos, CA (US); Xiao Z. Wu, San Jose, CA (US)

Correspondence Address: HITACHI C/O WAGNER BLECHER LLP, 123 WESTRIDGE DRIVE, WATSONVILLE, CA, 95076, US

(21) Appl. No.: 11/800,262

(22) Filed: May 3, 2007

(51) Int. Cl. G11B 21/02

(52) U.S. Cl. 360/234.3

(57) ABSTRACT

A disk drive head slider for a magnetic disk drive is provided. The head slider includes a tunnel magnetic resistance device for reading data on a magnetic disk and a dedicated sensor for measuring resistance wherein the resistance corresponds to a level of smear associated with the head slider.

### TECHNICAL FIELD

The field of the present invention relates to disk drive data storage devices. More particularly, embodiments of the present invention are related to sliders for hard disk drives.

### BACKGROUND ART

Direct access storage devices (DASD) have become part of every day life, and as such, expectations and demands continually increase for better performance at lower cost. To meet these demands, the mechano-electrical assembly in a DASD device, specifically the Hard Disk Drive (HDD) has evolved to meet these demands.

In order for an HDD to hold more data, advances in the disk media in which the data is written as well as the magnetic transducer for writing and reading the data have undergone major advances in the past few years.

The magnetic transducer used in the first hard disk drives was based on an inductive principle for both writing and reading data to and from the disk media. For writing data into the disk media, electric current is passed through an electrically conductive coil, which is wrapped around a ferromagnetic core. The electric current passing through the write coil induces a magnetic field in the core, which magnetizes a pattern of localized spots in the disk media as the disk media passes close to the magnetic transducer. The pattern of magnetized spots in the media forms data that can be read and manipulated by the HDD. To read this data, the disk passes the magnetized spots of written data close to the same magnetic core used for writing the data. The magnetized spots passing close to the ferromagnetic core induce a magnetic field in the core. The magnetic field induced in the ferromagnetic core induces an electric current in a read coil similar to the write coil. The HDD interprets the induced electric current from the read coil as data.

Magnetoresistance (MR) transducers replaced inductive read heads. An MR transducer reads written data in disk media, still in the form of magnetized spots, by sensing the change in electrical resistance of a magneto-resistive element in the MR transducer. An electric current is passed through an MR transducer. The current typically traverses the MR transducer perpendicularly to the direction of disk rotation and in the plane of the MR films.

Advances in the magneto-resistive element materials have made the MR transducer more sensitive and is now referred to as a giant magnetoresistance (GMR) transducer. As with the MR transducer, the current typically traverses the GMR transducer perpendicularly to the direction of disk rotation and in the plane of the GMR films, and the data is written in the disk media with an inductive write transducer.

Further advances in magneto-resistive reading have given rise to tunneling magnetoresistance (TMR) magnetic transducers. The current traversing the TMR magnetic transducer is typically parallel to the direction of disk rotation, and perpendicular to the TMR films. A thin insulator barrier is placed between two ferromagnetic conductors. Electrons tunnel through the thin insulator barrier. The resistance of the electrons tunneling through the thin insulator barrier will change as the magnetic domain structure within the two ferromagnetic conductors react to the presence of a magnetized spot in the disk media. In this manner, data can be read that has been magnetically written in the disk media.

Continuing advances are being made in the TMR magnetic transducer design and fabrication methods as more demands are made on the performance of HDDs using TMR magnetic transducers.

### SUMMARY OF EMBODIMENTS OF THE INVENTION

Embodiments of the present invention include a head slider for a magnetic disk drive. In one embodiment of the invention, the head slider includes a tunnel magnetic resistive device for reading data on a magnetic disk and a dedicated sensor for measuring resistance wherein the resistance corresponds to a level of smear associated with the disk drive head slider.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic, top plane view of a hard disk drive in accordance with one embodiment of the present invention.

FIG. 2 is an illustration of an exemplary row of sliders in accordance with embodiments of the present invention.

FIG. 3 is a cross sectional view of an exemplary current in plane (CIP) dedicated smear sensor in accordance with embodiments of the present invention.

FIG. 4 is a cross sectional view of an exemplary current perpendicular plane (CPP) dedicated smear sensor in accordance with embodiments of the present invention.

FIG. 5 is a flow diagram of an exemplary method for determining smear in accordance with embodiments of the present invention.

### DETAILED DESCRIPTION

Reference will now be made in detail to embodiment(s) of the present invention. While the invention will be described in conjunction with the embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

The discussion will begin with an overview of a hard disk drive and components connected within. The discussion will then focus on embodiments of the invention that provide a dedicated smear sensor in a slider for determining smear of a slider while the slider is being lapped. The discussion will then focus on embodiments of this invention that provide a method for determining smear. In one embodiment, the dedicated smear sensor enables real-time measurement and control of lapping. The present invention also provides a method for determining when a lapping process exceeds a threshold smear level.

Although embodiments of the present invention will be described in conjunction with a hard disk drive slider, it is understood that the embodiments described herein are useful outside of the art of disk drive sliders, such as devices requiring high frequency transmission between two devices that have relative motion.

### OVERVIEW

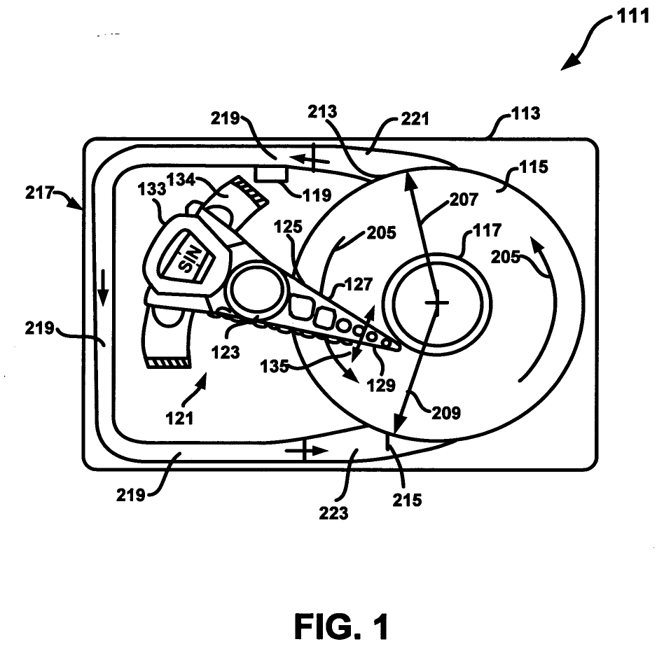

With reference now to FIG. 1, a schematic drawing of one embodiment of an information storage system comprising a magnetic hard disk file or drive 111 for a computer system is shown. Drive 111 has an outer housing or base 113 containing a disk pack having at least one media or magnetic disk 115. A spindle motor assembly having a central drive hub 117 rotates the disk or disks 115.

An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered electrical lead suspension (ELS) 127 (load beam removed). It should be understood that ELS 127 may be, in one embodiment, an integrated lead suspension (ILS) that is formed by a subtractive process.

In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer.

The ELS may be any form of lead suspension that can be used in a Data Access Storage Device, such as a HDD. A magnetic read/write transducer or head is mounted on a slider 129 and secured to a flexure that is flexibly mounted to each ELS 127. The read/write heads magnetically read data from and/or magnetically write data to disk 115. The level of integration called the head gimbal assembly is the head and the slider 129, which are mounted on suspension 127. The slider 129 is usually bonded to the end of ELS 127

ELS 127 has a spring-like quality, which biases or presses the air-bearing surface of the slider 129 against the disk 115 to cause the slider 129 to fly at a precise distance from the disk. The ELS 127 has a hinge area that provides for the spring-like quality, and a flexing interconnect that supports read and write traces through the hinge area. A voice coil 133, free to move within a conventional voice coil motor magnet assembly 134 (top pole not shown), is also mounted to arms 125 opposite the head gimbal assemblies.

Movement of the actuator 121 (indicated by arrow 135) by controller 119 causes the head gimbal assemblies to move along radial arcs across tracks on the disk 115 until the heads settle on their set target tracks. The head gimbal assemblies operate in a conventional manner and move in unison with one another, unless drive 111 uses multiple independent actuators (not shown) wherein the arms can move independently of one another.

Lapping is a necessary process used to define the base-plane of a slider's air bearing surface (ABS). Lapping is also used to define the stripe height of the recording sensors within the sliders. In most cases, lapping is performed by polishing sliders on diamond-embedded tin plates. The slider's magnetic sensors are vulnerable to damage during the lapping process.

For example, lapping debris (e.g., plate material, slider material, etc.) generated during lapping can become embedded in the sensor and cause electrical short circuits. It is often called “smearing” when conducting lapping debris bridges across the sensor.

Depending on the quality of the lapping process, the degree of “smearing” can vary drastically. For example, larger diamonds and scratches on the lapping plate can cause more severe smearing than clean plates and finer lapping material. If the degree of smearing is slight, it can be removed in post-lapping-processing, such as ion-beam-etching and/or cleaning. However, if the smearing is heavy, post processing will not adequately remove the smearing which can lead to head reliability problems.

For lapping GMR sensors, the GMR sensors themselves are often used as the smear sensors. As the GMR sensors are removed by lapping, its intrinsic resistance value should increase monotonically. Smearing caused by lapping will reduce the measured resistance values. Therefore any drops in the measured GMR resistance values are caused by smearing. But since the dimension of the GMR sensors change with every product generation, their sensitivity as the smear sensors changes too. It'd be ideal to have dedicated smear sensors, whose sensitivity remains constant.

For TMR sensors, the resistance values are mainly determined by a tunnel barrier which is only a few Angstrom thick. Therefore, they are extremely sensitive to lapping smearing. Even the finest lapping will generate very noisy resistance readings, even though the smearing may be cleaned up in the post-lapping processing. The TMR sensors are too sensitive so that they can not differentiate fine lapping from rough ones. Therefore it is necessary to have a dedicated smearing sensor for quality control of the lapping of the TMR sensors.

Embodiments of the present invention include a dedicated smear sensor formed within a slider that enables a real-time determination of the degree of smear associated with a single slider or a plurality of sliders during a lapping process. In one embodiment, the dedicated sensor is formed within sliders comprising tunneling magnetic recording (TMR) sensors.

In one embodiment of the invention, the dedicated smear sensor is used to monitor the level of smear during a lapping process and determine a “smear index” value associated with a slider or a plurality of sliders including TMR sensors. The smear index can be compared to a threshold smear value and when the smear index exceeds the threshold smear value, it can be determined that the lapping process should be adjusted, such as reducing the lapping pressure, speed, or replacing the lapping plates.

By monitoring the level of smear in real time with respect to the lapping process, fewer parts are discarded due to smearing because the lapping process can be adjusted to keep the smear index below the threshold value. Embodiments of the present invention monitor and provide instant feedback about the quality of the lapping process which enables improved process control.

Since the sensor materials are being removed during the lapping process, the intrinsic resistance of the sensor increases monotonically. However, smearing can cause current shunting across the barrier and resistance will drop across the barrier once smearing occurs, essentially creating an electrical short in the sensor. Since the TMR sensor barrier is sometimes as small as a few Angstrom, the resistance of the TMR sensor fluctuates wildly, even during the best of lapping conditions.

Embodiments of the present invention include a dedicated sensor for monitoring smearing where the sensor is not overly sensitive to smearing as is the TMR sensor. For example, embodiments of the present invention provide a dedicated smear sensor with a barrier thickness of approximately 10 nanometers, which greatly reduces the smearing sensitivity compared to the TMR sensor.

The dedicated smear sensor measures resistance to enable the determination of a “smear index” value. In one embodiment of the invention, the structure of the dedicated smear sensor shares similar manufacturing processes as the TMR sensor and can be formed using many of the same processing steps used to form the TMR sensor itself. As a result, the added manufacturing time and costs associated with adding a dedicated smear sensor to a slider is minimal.

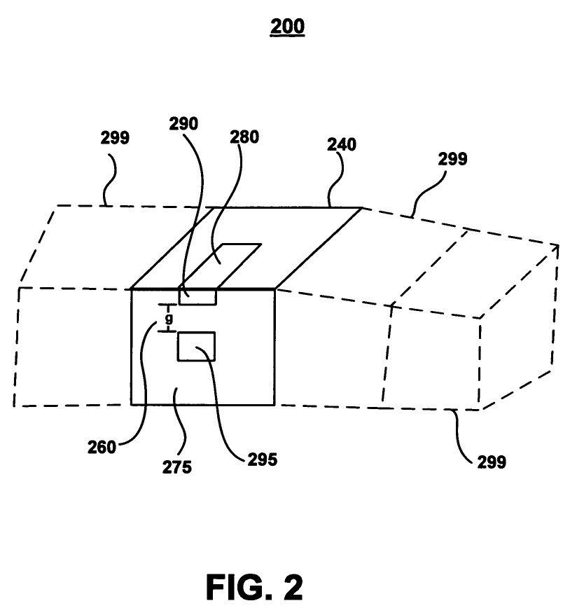

FIG. 2 is an illustration of an exemplary row of sliders 200 in accordance with embodiments of the present invention. Slider row 200 includes a plurality of sliders 299, however only slider 240 will be described for purposes of brevity and clarity. In one embodiment of the invention, not all of the sliders of the slider row 200 need a dedicated smear sensor 280. For example, a single smear sensor may be associated with a plurality of individual sliders.

The smear sensor 280 is exposed on lapping surface 275 of the slider row 200. In most cases, the lapping surface 275 is the air bearing surface of the sliders. The smear sensor 280 includes conducting layers 290 and 295 that are separated by a gap 260. FIG. 2 shows a current in plane (CIP) sensor, however, it is appreciated that any type of sensor structures could be used in accordance with embodiments of the present invention.

As stated above, the dedicated smear sensor 280 measures resistance. When debris (smearing) bridges the conducting plates 290 and 295, the resistance decreases, indicating a problem with the lapping process. In one embodiment, the smear sensor 280 is electrically monitored in real-time while the slider row is being lapped which provides instant feedback and enables quick response time to problems with the lapping process. It is appreciated that gap 260 have to be an insulating layer, not shown for clarity.

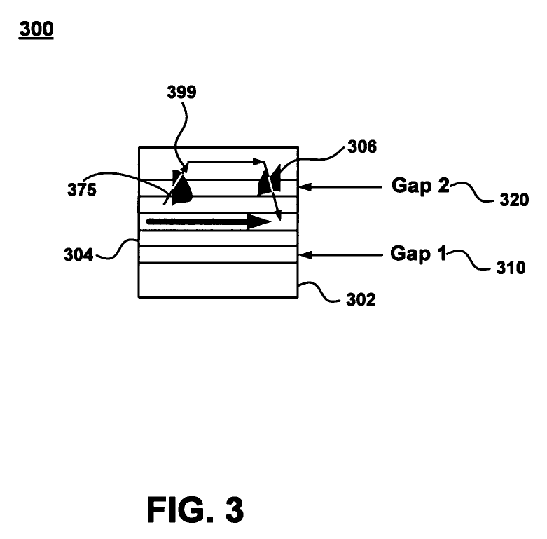

In one embodiment, the dedicated smear sensor is a current in plane (CIP) sensor, which can be formed concurrently with the TMR sensor. But the smear sensors may have less metal layers than the TMR sensors so that their insulating layers are thicker than the insulating barrier of the TMR sensors. This is necessary to bring their smearing sensitivity to the desired range to differentiate fine lapping from rough ones (TMR sensors are too sensitive). FIG. 3 is a cross sectional view of an example current in plane (CIP) dedicated smear sensor 300 in accordance with embodiments of the present invention. With a CIP sensor, sensor stacks 302, 304 and 306 are electrically isolated by insulating layers 310 and 320 of approximately 10 nanometers each, forming “gaps” 310 and 320.

Conducting debris 399 (e.g., smearing) that covers the “gap” will cause current shunting 375 and will be reflected as downward resistance of the CIP sensor. It is appreciated that the insulating layer or “gap” could be in the range of 5-40 nanometers, but could also be larger or smaller, depending on many factors, such as desired sensitivity of the CIP device to smearing. The smaller the “gap” the more sensitive the CIP sensor will be to smearing.

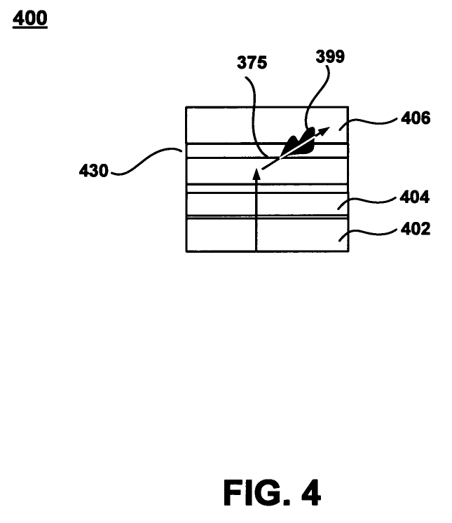

In another embodiment of the invention, the dedicated smear sensor is a current perpendicular plane (CPP) sensor, which can be formed concurrently with the TMR sensor. FIG. 4 is a cross sectional view of an example current perpendicular plane (CPP) dedicated smear sensor 400 in accordance with embodiments of the present invention. The CPP stack (402 and 404) is separated from the shield metal 406 with a gap 430 of approximately 10 nanometers. This large gap will limit the current flow, thus the resistance will be very large.

However, once the debris 399 (smearing) is bridged across the gap 430, the resistance will drop drastically because of current shunting 375. From the resistance values of the dedicated CPP sensor, a smear index can be determined. It is appreciated that the insulating layer or “gap” 430 could be in the range of 5-20 nanometers, but could also be larger or smaller, depending on many factors, such as desired sensitivity of the CPP device to smearing. The smaller the “gap” the more sensitive the CPP sensor will be to smearing.

Although CIP 300 and CPP 400 sensors are described herein as dedicated slider smear sensors, it is appreciated that any number of sensor configurations can be used in accordance with embodiments of the present invention. For example, a number of sensors could be wired together to enable measurement of smear.

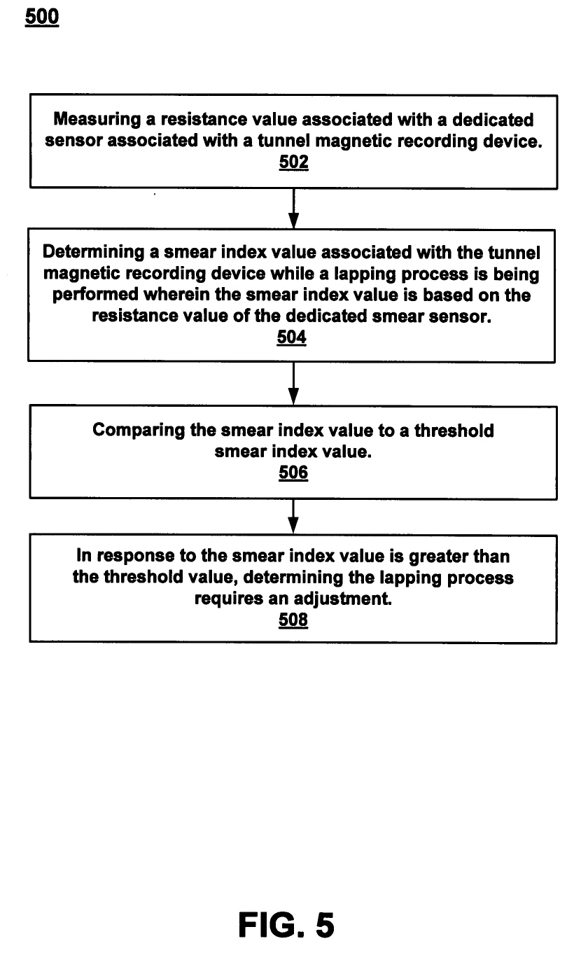

FIG. 5 is a flow diagram of an exemplary method 500 for determining a smear level associated with a slider in accordance with embodiments of the present invention. In one embodiment, method 500 is performed while a slider or a plurality of sliders are being lapped or are in a lapping process.

At 502, method 500 includes measuring a resistance value associated with a dedicated sensor associated with a tunnel magnetic recording device. In one embodiment, a CIP sensor or a CPP sensor is used to measure the resistance in 502.

At 504, method 500 includes determining a smear index value associated with the tunnel magnetic recording device while a lapping process is being performed wherein the smear index value is based on the resistance value of the dedicated smear sensor. It is appreciated that the “smear index” can be determined and or quantified in any number of ways in accordance with embodiments of the present invention. During lapping, the sensors become shorter and their intrinsic resistance values increase monotonically with time. Any drop of measured resistance values are due to current shunting by smearing. The smear index, for example, can be defined as the percentage of the resistance drops (normalized by the pre-drop values) average over a certain period of time.

At 506, method 500 includes comparing the smear index value to a threshold smear index value. The threshold value is the maximum allowable level of smear. Once the threshold is exceeded, the lapping process should be adjusted.

At 508, method 500 includes in response to the smear index value is greater than the threshold value, determining the lapping process requires an adjustment. It is appreciated that 508 can result in performing any necessary repairs and/or adjustments associated with the lapping process. For example, 508 can trigger changing lapping plates, adjusting lapping speed, changing slurry mixtures, etc. in accordance with embodiments of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A disk drive slider comprising:
a magnetic recording device; and
a dedicated sensor for measuring resistance, said resistance corresponding to a level of smear associated with said disk drive slider.

2. The disk drive slider as described in claim 1 wherein said dedicated sensor is used to determine said level of smear while simultaneously lapping said disk drive slider.

3. The disk drive slider as described in claim 1 wherein said dedicated sensor includes a current in plane (CIP) sensor.

4. The disk drive slider as described in claim 1 wherein said dedicated sensor includes a current perpendicular plane (CPP) sensor.

5. The disk drive slider as described in claim 1 wherein said dedicated sensor includes an electrical coupling mechanism for electrically coupling said dedicated sensor to a lapping control device.

6. The disk drive slider as described in claim 1 wherein said dedicated sensor includes an insulating gap, said insulating gap in the range of 5-15 nanometers.

7. A disk drive assembly comprising:
a rotatable magnetic disk; and
a head gimbal assembly coupled to an actuator, said head gimbal assembly comprising a head slider, said slider comprising:
a magnetic recording device; and
a dedicated sensor for measuring resistance, said resistance corresponding to a level of smear associated with said head slider.

8. The disk drive assembly as described in claim 7 wherein said dedicated sensor is used to determine said level of smear while simultaneously lapping said head slider.

9. The disk drive assembly as described in claim 7 wherein said dedicated sensor includes a current in plane (CIP) sensor.

10. The disk drive assembly as described in claim 7 wherein said dedicated sensor includes a current perpendicular plane (CPP) sensor.

11. The disk drive assembly as described in claim 7 wherein said dedicated sensor includes an electrical coupling mechanism for electrically coupling said dedicated sensor to a lapping control device.

12. The disk drive assembly as described in claim 7 wherein said dedicated sensor includes an insulating gap, said insulating gap in the range of 5-40 nanometers.

13. A method for determining a level of smear associated with a magnetic recording device comprising:
measuring a resistance value associated with a dedicated sensor associated with said magnetic recording device; and
determining a smear index value associated with said magnetic recording resistance device while a lapping process is being performed wherein said smear index value is based on said resistance value.

14. The method as described in claim 13 further comprising:
comparing said smear index value to a threshold smear index value.

15. The method as described in claim 14 further comprising:
in response to said smear index value is greater than said threshold value, determining said lapping process requires an adjustment.

16. The method as described in claim 13 further comprising:
controlling said lapping process based on said resistance value associated with said dedicated sensor.

17. A method for determining smear associated with a hard disk drive slider comprising:
forming a tunnel magnetic resistance device within said slider; and
forming a dedicated sensor within said slider for measuring resistance, said resistance corresponding to a level of smear associated with said slider.

18. The method of claim 17 wherein said dedicated sensor includes a current in plane (CIP) sensor.

19. The method of claim 17 wherein said dedicated sensor includes a current perpendicular plane (CPP) sensor.

20. The method as described in claim 17 further comprising:
determining a smear index value associated with said tunnel magnetic resistance device while a lapping process is being performed on said slider.

21. The method of claim 17 wherein said tunnel magnetic resistance device and said dedicated sensor are formed concurrently.
